(19) United States
(12) Patent Application Publication
(10) Pub. No.: US 2024/0113826 A1
(43) Pub. Date: Apr. 4, 2024

(54) METHOD AND APPARATUS FOR ESTIMATING CHANNEL STATE INFORMATION IN ADVANCED MIMO ANTENNA SYSTEMS FOR CELLULAR COMMUNICATIONS

(71) Applicant: Samsung Electronics Co., Ltd., Suwon-si (KR)

(72) Inventors: Young Han Nam, Plano, TX (US); Jianhua Mo, Allen, TX (US); Bilal Sadiq, Plano, TX (US); Ahmad AlAmmouri, Richardson, TX (US)

(21) Appl. No.: 18/468,627

(22) Filed: Sep. 15, 2023

Related U.S. Application Data
(60) Provisional application No. 63/410,488, filed on Sep. 27, 2022.
(60) Provisional application No. 63/466,534, filed on May 15, 2023.

(51) Int. Cl. H04L 5/00; H04B 7/0417; H04B 7/06; H04L 25/02

(52) U.S. Cl. CPC H04L 5/0048; H04B 7/0417; H04B 7/0626; H04L 25/0204

(57) ABSTRACT

Methods and apparatuses for estimating channel state information in advanced multi input multi output (MIMO) antenna systems for cellular communications. A method of operating a base station (BS) includes: generating first configuration information including a set of sounding reference signal (SRS) resources each of which is associated with an sounding reference signal (SRS)-path loss reference signal; transmitting, to a user equipment (UE), the first configuration information; receiving an SRS based on the first configuration information; selecting, based on the SRS and the first configuration information, a subset of the set of SRS resources; and generating second configuration information including the subset of the set of SRS resources.

### CROSS-REFERENCE TO RELATED APPLICATIONS AND CLAIM OF PRIORITY

The present application claims priority to U.S. Provisional Patent Application No. 63/410,488, filed on Sep. 27, 2022, and U.S. Provisional Patent Application No. 63/466,534, filed on May 15, 2023. The contents of the above-identified patent documents are incorporated herein by reference.

### TECHNICAL FIELD

The present disclosure relates generally to wireless communication systems and, more specifically, the present disclosure relates to estimating channel state information in advanced multi input multi output (MIMO) antenna systems for cellular communications.

### BACKGROUND

5th generation (5G) or new radio (NR) mobile communications is recently gathering increased momentum with all the worldwide technical activities on the various candidate technologies from industry and academia. The candidate enablers for the 5G/NR mobile communications include massive antenna technologies, from legacy cellular frequency bands up to high frequencies, to provide beamforming gain and support increased capacity, new waveform (e.g., a new radio access technology (RAT)) to flexibly accommodate various services/applications with different requirements, new multiple access schemes to support massive connections, and so on.

### SUMMARY

The present disclosure relates to wireless communication systems and, more specifically, the present disclosure relates to support estimating channel state information in advanced MIMO antenna systems for cellular communications.

In one embodiment, a base station (BS) is provided. The BS comprises a processor configured to generate first configuration information including a set of sounding reference signal (SRS) resources each of which is associated with an SRS-path loss reference signal. The BS further comprises a transceiver operably coupled to the processor, the transceiver configured to: transmit, to a user equipment (UE), the first configuration information, and receive an SRS based on the first configuration information. The processor of the BS is further configured to select, based on the SRS and the first configuration information, a subset of the set of SRS resources, and generate second configuration information including the subset of the set of SRS resources.

In another embodiment, a method of a BS is provided. The method comprises: generating first configuration information including a set of SRS resources each of which is associated with an SRS-path loss reference signal; transmitting, to a UE, the first configuration information; receiving an SRS based on the first configuration information; selecting, based on the SRS and the first configuration information, a subset of the set of SRS resources; and generating second configuration information including the subset of the set of SRS resources.

In yet another embodiment, a UE is provided. The UE comprises a transceiver configured to receive, from a BS, first configuration information. The UE further comprises a processor operably coupled to the transceiver, the processor configured to identify the first configuration information including a set of SRS resources each of which is associated with an SRS-path loss reference signal for transmitting an SRS. The transceiver of the UE is further configured to transmit, to the BS, the SRS based on the first configuration information, a subset of the set of SRS resources is selected based on the SRS and the first configuration information, and second configuration information including the subset of the set of SRS resources is identified based on subset of the set of SRS resources.

Other technical features may be readily apparent to one skilled in the art from the following figures, descriptions, and claims.

Before undertaking the DETAILED DESCRIPTION below, it may be advantageous to set forth definitions of certain words and phrases used throughout this patent document. The term “couple” and its derivatives refer to any direct or indirect communication between two or more elements, whether or not those elements are in physical contact with one another. The terms “transmit,” “receive,” and “communicate,” as well as derivatives thereof, encompass both direct and indirect communication. The terms “include” and “comprise,” as well as derivatives thereof, mean inclusion without limitation. The term “or” is inclusive, meaning and/or. The phrase “associated with,” as well as derivatives thereof, means to include, be included within, interconnect with, contain, be contained within, connect to or with, couple to or with, be communicable with, cooperate with, interleave, juxtapose, be proximate to, be bound to or with, have, have a property of, have a relationship to or with, or the like. The term “controller” means any device, system, or part thereof that controls at least one operation. Such a controller may be implemented in hardware or a combination of hardware and software and/or firmware. The functionality associated with any particular controller may be centralized or distributed, whether locally or remotely. The phrase “at least one of,” when used with a list of items, means that different combinations of one or more of the listed items may be used, and only one item in the list may be needed. For example, “at least one of: A, B, and C” includes any of the following combinations: A, B, C, A and B, A and C, B and C, and A and B and C.

Moreover, various functions described below can be implemented or supported by one or more computer programs, each of which is formed from computer readable program code and embodied in a computer readable medium. The terms “application” and “program” refer to one or more computer programs, software components, sets of instructions, procedures, functions, objects, classes, instances, related data, or a portion thereof adapted for implementation in a suitable computer readable program code. The phrase “computer readable program code” includes any type of computer code, including source code, object code, and executable code. The phrase “computer readable medium” includes any type of medium capable of being accessed by a computer, such as read only memory (ROM), random access memory (RAM), a hard disk drive, a compact disc (CD), a digital video disc (DVD), or any other type of memory. A “non-transitory” computer readable medium excludes wired, wireless, optical, or other communication links that transport transitory electrical or other signals. A non-transitory computer readable medium includes media where data can be permanently stored and media where data can be stored and later overwritten, such as a rewritable optical disc or an erasable memory device.

Definitions for other certain words and phrases are provided throughout this patent document. Those of ordinary skill in the art should understand that in many if not most instances, such definitions apply to prior as well as future uses of such defined words and phrases.

### BRIEF DESCRIPTION OF THE DRAWINGS

For a more complete understanding of the present disclosure and its advantages, reference is now made to the following description taken in conjunction with the accompanying drawings, in which like reference numerals represent like parts:

FIG. 1 illustrates an example of wireless network according to embodiments of the present disclosure;

FIG. 2 illustrates an example of gNB according to embodiments of the present disclosure;

FIG. 3 illustrates an example of UE according to embodiments of the present disclosure;

FIGS. 4 and 5 illustrate examples of wireless transmit and receive paths according to this disclosure;

FIG. 6 illustrates an example of antenna structure according to embodiments of the present disclosure;

FIG. 7 illustrates an example of an antenna panel comprising NT antenna elements according to embodiments of the present disclosure;

FIG. 8 illustrates an example of a RF frontend and baseband implementation for a base station according to embodiments of the present disclosure;

FIG. 9 illustrates an example of chain of signal processing modules according to embodiments of the present disclosure;

FIG. 10 illustrates an example of SRS reception and processing according to embodiments of the present disclosure;

FIG. 11 illustrates an example of MIMO channel estimation according to embodiments of the present disclosure;

FIG. 12 illustrates a flowchart of BS method for obtaining N_{D} SRS channel measurements per subcarrier according to embodiments of the present disclosure;

FIG. 13 illustrates a flowchart of BS method to reconstruct a channel matrix according to embodiments of the present disclosure;

FIG. 14 illustrates a flowchart of BS method for a subset of SRS analog beams according to embodiments of the present disclosure;

FIG. 15A illustrates a flowchart of BS method to configure multiple SRS resources according to embodiments of the present disclosure;

FIG. 15B illustrates a flowchart of UE method to configure multiple SRS resources according to embodiments of the present disclosure;

FIG. 16A illustrates a flowchart of BS method to inform the down-selection of SRS resources according to embodiments of the present disclosure;

FIG. 16B illustrates a flowchart of UE method to inform the down-selection of SRS resources according to embodiments of the present disclosure;

FIG. 17 illustrates a flowchart of BS method for two SRS resource set configuration and management according to embodiments of the present disclosure; and

FIG. 18 illustrates a flowchart of BS method for estimating channel state information according to embodiments of the present disclosure.

### DETAILED DESCRIPTION

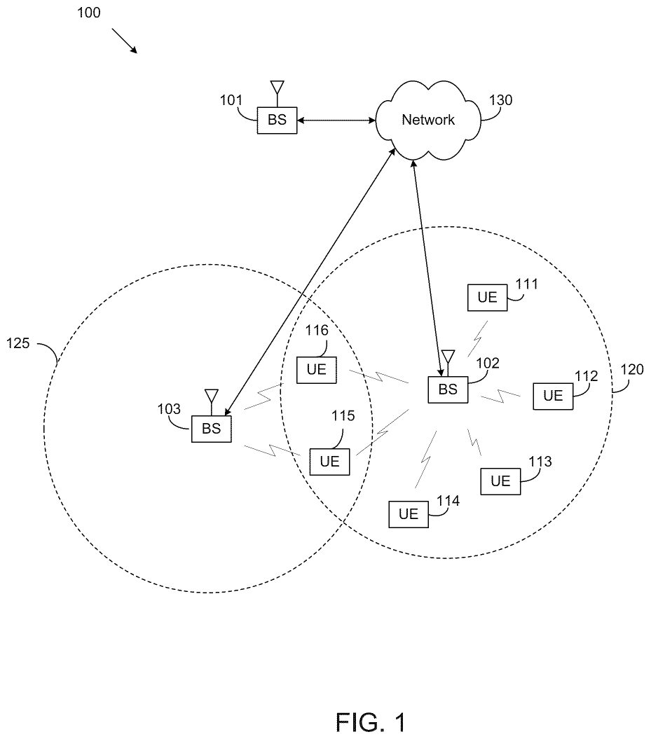

FIG. 1 through FIG. 18, discussed below, and the various embodiments used to describe the principles of the present disclosure in this patent document are by way of illustration only and should not be construed in any way to limit the scope of the disclosure. Those skilled in the art will understand that the principles of the present disclosure may be implemented in any suitably arranged system or device.

To meet the demand for wireless data traffic having increased since deployment of 4G communication systems and to enable various vertical applications, 5G/NR communication systems have been developed and are currently being deployed. The 5G/NR communication system is considered to be implemented in higher frequency (mmWave) bands, e.g., 28 GHz or 60 GHz bands, so as to accomplish higher data rates or in lower frequency bands, such as 6 GHz, to enable robust coverage and mobility support. To decrease propagation loss of the radio waves and increase the transmission distance, the beamforming, massive MIMO, full dimensional MIMO (FD-MIMO), array antenna, an analog beam forming, large scale antenna techniques are discussed in 5G/NR communication systems.

In addition, in 5G/NR communication systems, development for system network improvement is under way based on advanced small cells, cloud radio access networks (RANs), ultra-dense networks, device-to-device (D2D) communication, wireless backhaul, moving network, cooperative communication, coordinated multi-points (CoMP), reception-end interference cancelation and the like.

The discussion of 5G systems and frequency bands associated therewith is for reference as certain embodiments of the present disclosure may be implemented in 5G systems. However, the present disclosure is not limited to 5G systems, or the frequency bands associated therewith, and embodiments of the present disclosure may be utilized in connection with any frequency band. For example, aspects of the present disclosure may also be applied to deployment of 5G communication systems, 6G or even later releases which may use terahertz (THz) bands.

FIGS. 1-3 below describe various embodiments implemented in wireless communications systems and with the use of orthogonal frequency division multiplexing (OFDM) or orthogonal frequency division multiple access (OFDMA) communication techniques. The descriptions of FIGS. 1-3 are not meant to imply physical or architectural limitations to the manner in which different embodiments may be implemented. Different embodiments of the present disclosure may be implemented in any suitably arranged communications system.

FIG. 1 illustrates an example wireless network according to embodiments of the present disclosure. The embodiment of the wireless network shown in FIG. 1 is for illustration only. Other embodiments of the wireless network 100 could be used without departing from the scope of this disclosure.

As shown in FIG. 1, the wireless network includes a gNB 101 (e.g., base station, BS), a gNB 102, and a gNB 103. The gNB 101 communicates with the gNB 102 and the gNB 103. The gNB 101 also communicates with at least one network 130, such as the Internet, a proprietary Internet Protocol (IP) network, or other data network.

The gNB 102 provides wireless broadband access to the network 130 for a first plurality of user equipments (UEs) within a coverage area 120 of the gNB 102. The first plurality of UEs includes a UE 111, which may be located in a small business; a UE 112, which may be located in an enterprise; a UE 113, which may be a WiFi hotspot; a UE 114, which may be located in a first residence; a UE 115, which may be located in a second residence; and a UE 116, which may be a mobile device, such as a cell phone, a wireless laptop, a wireless PDA, or the like. The gNB 103 provides wireless broadband access to the network 130 for a second plurality of UEs within a coverage area 125 of the gNB 103. The second plurality of UEs includes the UE 115 and the UE 116. In some embodiments, one or more of the gNBs 101-103 may communicate with each other and with the UEs 111-116 using 5G/NR, long term evolution (LTE), long term evolution-advanced (LTE-A), WiMAX, WiFi, or other wireless communication techniques.

Depending on the network type, the term “base station” or “BS” can refer to any component (or collection of components) configured to provide wireless access to a network, such as transmit point (TP), transmit-receive point (TRP), an enhanced base station (eNodeB or eNB), a 5G/NR base station (gNB), a macrocell, a femtocell, a WiFi access point (AP), or other wirelessly enabled devices. Base stations may provide wireless access in accordance with one or more wireless communication protocols, e.g., 5G/NR 3^{rd} generation partnership project (3GPP) NR, long term evolution (LTE), LTE advanced (LTE-A), high speed packet access (HSPA), Wi-Fi 802.11a/b/g/n/ac, etc. For the sake of convenience, the terms “BS” and “TRP” are used interchangeably in this patent document to refer to network infrastructure components that provide wireless access to remote terminals. Also, depending on the network type, the term “user equipment” or “UE” can refer to any component such as “mobile station,” “subscriber station,” “remote terminal,” “wireless terminal,” “receive point,” or “user device.” For the sake of convenience, the terms “user equipment” and “UE” are used in this patent document to refer to remote wireless equipment that wirelessly accesses a BS, whether the UE is a mobile device (such as a mobile telephone or smartphone) or is normally considered a stationary device (such as a desktop computer or vending machine).

Dotted lines show the approximate extents of the coverage areas 120 and 125, which are shown as approximately circular for the purposes of illustration and explanation only. It should be clearly understood that the coverage areas associated with gNBs, such as the coverage areas 120 and 125, may have other shapes, including irregular shapes, depending upon the configuration of the gNBs and variations in the radio environment associated with natural and man-made obstructions.

As described in more detail below, one or more of the UEs 111-116 include circuitry, programing, or a combination thereof, for estimating channel state information in advanced MIMO antenna systems for cellular communications. In certain embodiments, and one or more of the gNBs 101-103 includes circuitry, programing, or a combination thereof, for estimating channel state information in advanced MIMO antenna systems for cellular communications.

Although FIG. 1 illustrates one example of a wireless network, various changes may be made to FIG. 1. For example, the wireless network could include any number of gNBs and any number of UEs in any suitable arrangement. Also, the gNB 101 could communicate directly with any number of UEs and provide those UEs with wireless broadband access to the network 130. Similarly, each gNB 102-103 could communicate directly with the network 130 and provide UEs with direct wireless broadband access to the network 130. Further, the gNBs 101, 102, and/or 103 could provide access to other or additional external networks, such as external telephone networks or other types of data networks.

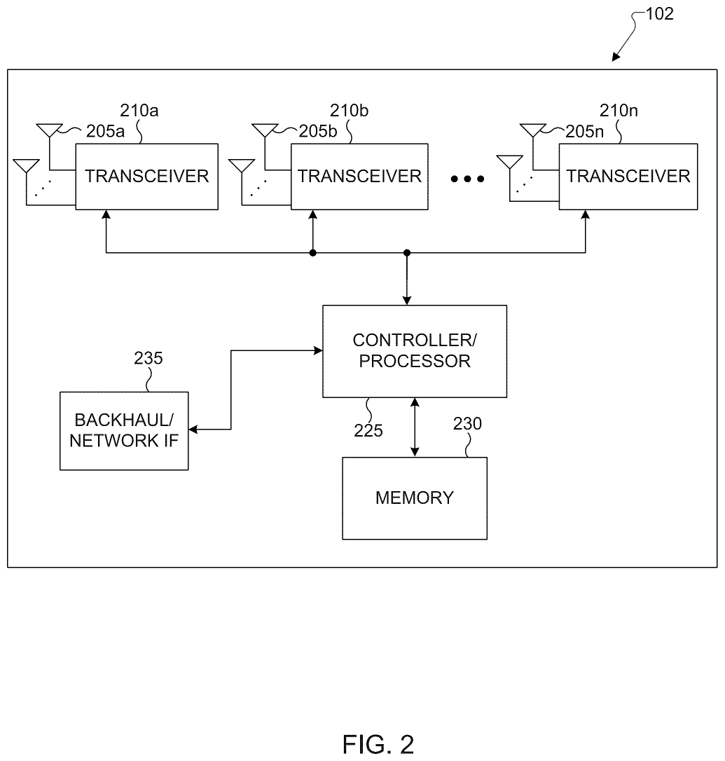

FIG. 2 illustrates an example gNB 102 according to embodiments of the present disclosure. The embodiment of the gNB 102 illustrated in FIG. 2 is for illustration only, and the gNBs 101 and 103 of FIG. 1 could have the same or similar configuration. However, gNBs come in a wide variety of configurations, and FIG. 2 does not limit the scope of this disclosure to any particular implementation of a gNB.

As shown in FIG. 2, the gNB 102 includes multiple antennas 205a-205n, multiple transceivers 210a-210n, a controller/processor 225, a memory 230, and a backhaul or network interface 235.

The transceivers 210a-210n receive, from the antennas 205a-205n, incoming RF signals, such as signals transmitted by UEs in the network 100. The transceivers 210a-210n down-convert the incoming RF signals to generate IF or baseband signals. The IF or baseband signals are processed by receive (RX) processing circuitry in the transceivers 210a-210n and/or controller/processor 225, which generates processed baseband signals by filtering, decoding, and/or digitizing the baseband or IF signals. The controller/processor 225 may further process the baseband signals.

Transmit (TX) processing circuitry in the transceivers 210a-210n and/or controller/processor 225 receives analog or digital data (such as voice data, web data, e-mail, or interactive video game data) from the controller/processor 225. The TX processing circuitry encodes, multiplexes, and/or digitizes the outgoing baseband data to generate processed baseband or IF signals. The transceivers 210a-210n up-converts the baseband or IF signals to RF signals that are transmitted via the antennas 205a-205n.

The controller/processor 225 can include one or more processors or other processing devices that control the overall operation of the gNB 102. For example, the controller/processor 225 could control the reception of UL channel signals and the transmission of DL channel signals by the transceivers 210a-210n in accordance with well-known principles. The controller/processor 225 could support additional functions as well, such as more advanced wireless communication functions. For instance, the controller/processor 225 could support beam forming or directional routing operations in which outgoing/incoming signals from/to multiple antennas 205a-205n are weighted differently to effectively steer the outgoing signals in a desired direction. Any of a wide variety of other functions could be supported in the gNB 102 by the controller/processor 225.

The controller/processor 225 is also capable of executing programs and other processes resident in the memory 230, such as processes for estimating channel state information in advanced MIMO antenna systems for cellular communications. The controller/processor 225 can move data into or out of the memory 230 as required by an executing process.

The controller/processor 225 is also coupled to the backhaul or network interface 235. The backhaul or network interface 235 allows the gNB 102 to communicate with other devices or systems over a backhaul connection or over a network. The interface 235 could support communications over any suitable wired or wireless connection(s). For example, when the gNB 102 is implemented as part of a cellular communication system (such as one supporting 5G/NR, LTE, or LTE-A), the interface 235 could allow the gNB 102 to communicate with other gNBs over a wired or wireless backhaul connection. When the gNB 102 is implemented as an access point, the interface 235 could allow the gNB 102 to communicate over a wired or wireless local area network or over a wired or wireless connection to a larger network (such as the Internet). The interface 235 includes any suitable structure supporting communications over a wired or wireless connection, such as an Ethernet or transceiver.

The memory 230 is coupled to the controller/processor 225. Part of the memory 230 could include a RAM, and another part of the memory 230 could include a Flash memory or other ROM.

Although FIG. 2 illustrates one example of gNB 102, various changes may be made to FIG. 2. For example, the gNB 102 could include any number of each component shown in FIG. 2. Also, various components in FIG. 2 could be combined, further subdivided, or omitted and additional components could be added according to particular needs.

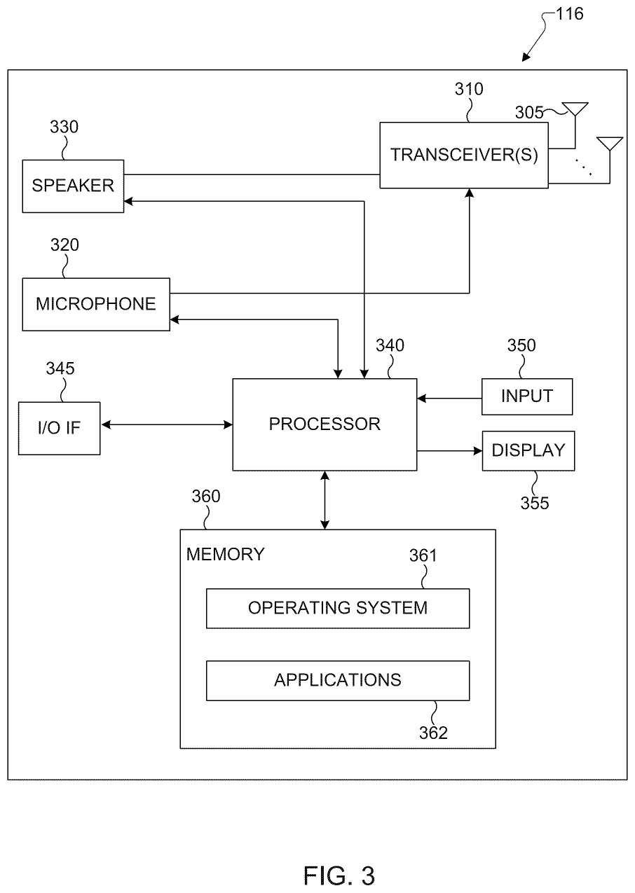

FIG. 3 illustrates an example UE 116 according to embodiments of the present disclosure. The embodiment of the UE 116 illustrated in FIG. 3 is for illustration only, and the UEs 111-115 of FIG. 1 could have the same or similar configuration. However, UEs come in a wide variety of configurations, and FIG. 3 does not limit the scope of this disclosure to any particular implementation of a UE.

As shown in FIG. 3, the UE 116 includes antenna(s) 305, a transceiver(s) 310, and a microphone 320. The UE 116 also includes a speaker 330, a processor 340, an input/output (I/O) interface (IF) 345, an input 350, a display 355, and a memory 360. The memory 360 includes an operating system (OS) 361 and one or more applications 362.

The transceiver(s) 310 receives from the antenna 305, an incoming RF signal transmitted by a gNB of the network 100. The transceiver(s) 310 down-converts the incoming RF signal to generate an intermediate frequency (IF) or baseband signal. The IF or baseband signal is processed by RX processing circuitry in the transceiver(s) 310 and/or processor 340, which generates a processed baseband signal by filtering, decoding, and/or digitizing the baseband or IF signal. The RX processing circuitry sends the processed baseband signal to the speaker 330 (such as for voice data) or is processed by the processor 340 (such as for web browsing data).

TX processing circuitry in the transceiver(s) 310 and/or processor 340 receives analog or digital voice data from the microphone 320 or other outgoing baseband data (such as web data, e-mail, or interactive video game data) from the processor 340. The TX processing circuitry encodes, multiplexes, and/or digitizes the outgoing baseband data to generate a processed baseband or IF signal. The transceiver(s) 310 up-converts the baseband or IF signal to an RF signal that is transmitted via the antenna(s) 305.

The processor 340 can include one or more processors or other processing devices and execute the OS 361 stored in the memory 360 in order to control the overall operation of the UE 116. For example, the processor 340 could control the reception of DL channel signals and the transmission of UL channel signals by the transceiver(s) 310 in accordance with well-known principles. In some embodiments, the processor 340 includes at least one microprocessor or microcontroller.

The processor 340 is also capable of executing other processes and programs resident in the memory 360, such as processes for estimating channel state information in advanced MIMO antenna systems for cellular communications.

The processor 340 can move data into or out of the memory 360 as required by an executing process. In some embodiments, the processor 340 is configured to execute the applications 362 based on the OS 361 or in response to signals received from gNBs or an operator. The processor 340 is also coupled to the I/O interface 345, which provides the UE 116 with the ability to connect to other devices, such as laptop computers and handheld computers. The I/0 interface 345 is the communication path between these accessories and the processor 340.

The processor 340 is also coupled to the input 350 and the display 355m which includes for example, a touchscreen, keypad, etc., The operator of the UE 116 can use the input 350 to enter data into the UE 116. The display 355 may be a liquid crystal display, light emitting diode display, or other display capable of rendering text and/or at least limited graphics, such as from web sites.

The memory 360 is coupled to the processor 340. Part of the memory 360 could include a random-access memory (RAM), and another part of the memory 360 could include a Flash memory or other read-only memory (ROM).

Although FIG. 3 illustrates one example of UE 116, various changes may be made to FIG. 3. For example, various components in FIG. 3 could be combined, further subdivided, or omitted and additional components could be added according to particular needs. As a particular example, the processor 340 could be divided into multiple processors, such as one or more central processing units (CPUs) and one or more graphics processing units (GPUs). In another example, the transceiver(s) 310 may include any number of transceivers and signal processing chains and may be connected to any number of antennas. Also, while FIG. 3 illustrates the UE 116 configured as a mobile telephone or smartphone, UEs could be configured to operate as other types of mobile or stationary devices.

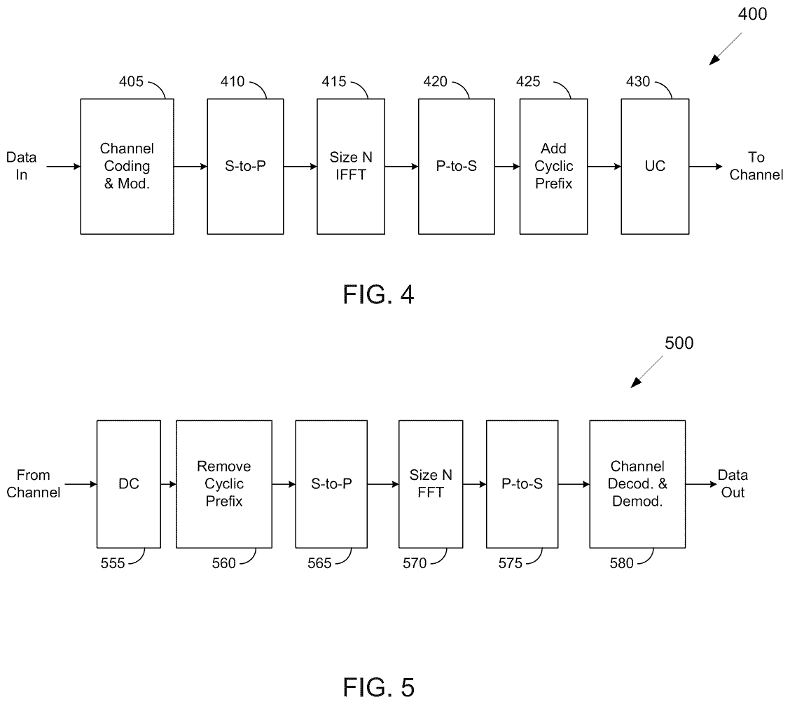

FIG. 4 and FIG. 5 illustrate example wireless transmit and receive paths according to this disclosure. In the following description, a transmit path 400 may be described as being implemented in a gNB (such as the gNB 102), while a receive path 500 may be described as being implemented in a UE (such as a UE 116). However, it may be understood that the receive path 500 can be implemented in a gNB and that the transmit path 400 can be implemented in a UE. In some embodiments, the receive path 500 is configured to support estimating channel state information in advanced MIMO antenna systems for cellular communications.

The transmit path 400 as illustrated in FIG. 4 includes a channel coding and modulation block 405, a serial-to-parallel (S-to-P) block 410, a size N inverse fast Fourier transform (IFFT) block 415, a parallel-to-serial (P-to-S) block 420, an add cyclic prefix block 425, and an up-converter (UC) 430. The receive path 500 as illustrated in FIG. 5 includes a down-converter (DC) 555, a remove cyclic prefix block 560, a serial-to-parallel (S-to-P) block 565, a size N fast Fourier transform (FFT) block 570, a parallel-to-serial (P-to-S) block 575, and a channel decoding and demodulation block 580.

As illustrated in FIG. 4, the channel coding and modulation block 405 receives a set of information bits, applies coding (such as a low-density parity check (LDPC) coding), and modulates the input bits (such as with quadrature phase shift keying (QPSK) or quadrature amplitude modulation (QAM)) to generate a sequence of frequency-domain modulation symbols.

The serial-to-parallel block 410 converts (such as de-multiplexes) the serial modulated symbols to parallel data in order to generate N parallel symbol streams, where N is the IFFT/FFT size used in the gNB 102 and the UE 116. The size N IFFT block 415 performs an IFFT operation on the N parallel symbol streams to generate time-domain output signals. The parallel-to-serial block 420 converts (such as multiplexes) the parallel time-domain output symbols from the size N IFFT block 415 in order to generate a serial time-domain signal. The add cyclic prefix block 425 inserts a cyclic prefix to the time-domain signal. The up-converter 430 modulates (such as up-converts) the output of the add cyclic prefix block 425 to an RF frequency for transmission via a wireless channel. The signal may also be filtered at baseband before conversion to the RF frequency.

A transmitted RF signal from the gNB 102 arrives at the UE 116 after passing through the wireless channel, and reverse operations to those at the gNB 102 are performed at the UE 116.

As illustrated in FIG. 5, the downconverter 555 down-converts the received signal to a baseband frequency, and the remove cyclic prefix block 560 removes the cyclic prefix to generate a serial time-domain baseband signal. The serial-to-parallel block 565 converts the time-domain baseband signal to parallel time domain signals. The size N FFT block 570 performs an FFT algorithm to generate N parallel frequency-domain signals. The parallel-to-serial block 575 converts the parallel frequency-domain signals to a sequence of modulated data symbols. The channel decoding and demodulation block 580 demodulates and decodes the modulated symbols to recover the original input data stream.

Each of the gNB s 101-103 may implement a transmit path 400 as illustrated in FIG. 4 that is analogous to transmitting in the downlink to UEs 111-116 and may implement a receive path 500 as illustrated in FIG. 5 that is analogous to receiving in the uplink from UEs 111-116. Similarly, each of UEs 111-116 may implement the transmit path 400 for transmitting in the uplink to the gNBs 101-103 and may implement the receive path 500 for receiving in the downlink from the gNBs 101-103.

Each of the components in FIG. 4 and FIG. 5 can be implemented using only hardware or using a combination of hardware and software/firmware. As a particular example, at least some of the components in FIGS. 4 and FIG. 5 may be implemented in software, while other components may be implemented by configurable hardware or a mixture of software and configurable hardware. For instance, the FFT block 570 and the IFFT block 415 may be implemented as configurable software algorithms, where the value of size N may be modified according to the implementation.

Furthermore, although described as using FFT and IFFT, this is by way of illustration only and may not be construed to limit the scope of this disclosure. Other types of transforms, such as discrete Fourier transform (DFT) and inverse discrete Fourier transform (IDFT) functions, can be used. It may be appreciated that the value of the variable N may be any integer number (such as 1, 2, 3, 4, or the like) for DFT and IDFT functions, while the value of the variable N may be any integer number that is a power of two (such as 1, 2, 4, 8, 16, or the like) for FFT and IFFT functions.

Although FIG. 4 and FIG. 5 illustrate examples of wireless transmit and receive paths, various changes may be made to FIG. 4 and FIG. 5. For example, various components in FIG. 4 and FIG. 5 can be combined, further subdivided, or omitted and additional components can be added according to particular needs. Also, FIG. 4 and FIG. 5 are meant to illustrate examples of the types of transmit and receive paths that can be used in a wireless network. Any other suitable architectures can be used to support wireless communications in a wireless network.

A unit for DL signaling or for UL signaling on a cell is referred to as a slot and can include one or more symbols. A bandwidth (BW) unit is referred to as a resource block (RB). One RB includes a number of sub-carriers (SCs). For example, a slot can have duration of one millisecond and an RB can have a bandwidth of 180 KHz and include 12 SCs with inter-SC spacing of 15 KHz. A slot can be either full DL slot, or full UL slot, or hybrid slot similar to a special subframe in time division duplex (TDD) systems.

DL signals include data signals conveying information content, control signals conveying DL control information (DCI), and reference signals (RS) that are also known as pilot signals. A gNB transmits data information or DCI through respective physical DL shared channels (PDSCHs) or physical DL control channels (PDCCHs). A PDSCH or a PDCCH can be transmitted over a variable number of slot symbols including one slot symbol. A UE can be indicated a spatial setting for a PDCCH reception based on a configuration of a value for a TCI state of a CORESET where the UE receives the PDCCH. The UE can be indicated a spatial setting for a PDSCH reception based on a configuration by higher layers or based on an indication by a DCI format scheduling the PDSCH reception of a value for a TCI state. The gNB can configure the UE to receive signals on a cell within a DL bandwidth part (BWP) of the cell DL BW.

A gNB transmits one or more of multiple types of RS including channel state information RS (CSI-RS) and demodulation RS (DMRS). A CSI-RS is primarily intended for UEs to perform measurements and provide channel state information (CSI) to a gNB. For channel measurement, non-zero power CSI-RS (NZP CSI-RS) resources are used. For interference measurement reports (IMRs), CSI interference measurement (CSI-IM) resources associated with a zero power CSI-RS (ZP CSI-RS) configuration are used. A CSI process includes NZP CSI-RS and CSI-IM resources. A UE can determine CSI-RS transmission parameters through DL control signaling or higher layer signaling, such as an RRC signaling from a gNB. Transmission instances of a CSI-RS can be indicated by DL control signaling or configured by higher layer signaling. A DMRS is transmitted only in the BW of a respective PDCCH or PDSCH and a UE can use the DMRS to demodulate data or control information.

UL signals also include data signals conveying information content, control signals conveying UL control information (UCI), DMRS associated with data or UCI demodulation, sounding RS (SRS) enabling a gNB to perform UL channel measurement, and a random access (RA) preamble enabling a UE to perform random access. A UE transmits data information or UCI through a respective physical UL shared channel (PUSCH) or a physical UL control channel (PUCCH). A PUSCH or a PUCCH can be transmitted over a variable number of slot symbols including one slot symbol. The gNB can configure the UE to transmit signals on a cell within an UL BWP of the cell UL BW.

UCI includes hybrid automatic repeat request acknowledgement (HARQ-ACK) information, indicating correct or incorrect detection of data transport blocks (TB s) in a PDSCH, scheduling request (SR) indicating whether a UE has data in the buffer of UE, and CSI reports enabling a gNB to select appropriate parameters for PDSCH or PDCCH transmissions to a UE. HARQ-ACK information can be configured to be with a smaller granularity than per TB and can be per data code block (CB) or per group of data CBs where a data TB includes a number of data CBs.

A CSI report from a UE can include a channel quality indicator (CQI) informing a gNB of a largest modulation and coding scheme (MCS) for the UE to detect a data TB with a predetermined block error rate (BLER), such as a 10% BLER, of a precoding matrix indicator (PMI) informing a gNB how to combine signals from multiple transmitter antennas in accordance with a MIMO transmission principle, and of a rank indicator (RI) indicating a transmission rank for a PDSCH. UL RS includes DMRS and SRS. DMRS is transmitted only in a BW of a respective PUSCH or PUCCH transmission. A gNB can use a DMRS to demodulate information in a respective PUSCH or PUCCH. SRS is transmitted by a UE to provide a gNB with an UL CSI and, for a TDD system, an SRS transmission can also provide a PMI for DL transmission. Additionally, in order to establish synchronization or an initial higher layer connection with a gNB, a UE can transmit a physical random-access channel.

In the present disclosure, a beam is determined by either of: (1) a TCI state, which establishes a quasi-colocation (QCL) relationship between a source reference signal (e.g., synchronization signal/physical broadcasting channel (PBCH) block (SSB) and/or CSI-RS) and a target reference signal; or (2) spatial relation information that establishes an association to a source reference signal, such as SSB or CSI-RS or SRS. In either case, the ID of the source reference signal identifies the beam.

The TCI state and/or the spatial relation reference RS can determine a spatial Rx filter for reception of downlink channels at the UE, or a spatial Tx filter for transmission of uplink channels from the UE.

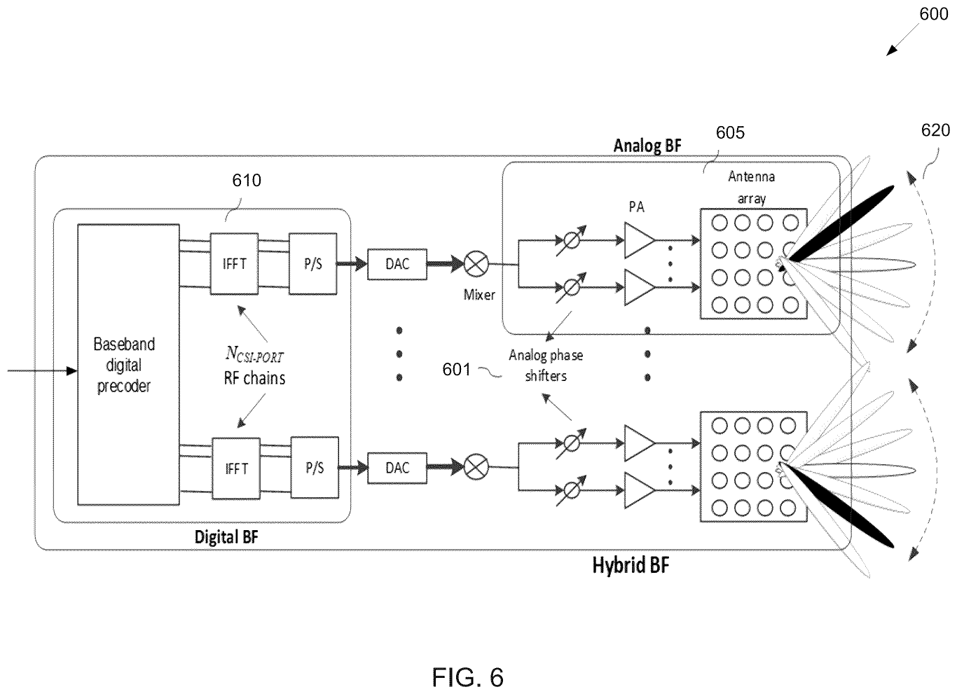

Rel.14 LTE and Rel.15 NR support up to 32 CSI-RS antenna ports which enable an eNB to be equipped with a large number of antenna elements (such as 64 or 128). In this case, a plurality of antenna elements is mapped onto one CSI-RS port. For mmWave bands, although the number of antenna elements can be larger for a given form factor, the number of CSI-RS ports—which can correspond to the number of digitally precoded ports—tends to be limited due to hardware constraints (such as the feasibility to install a large number of ADCs/DACs at mmWave frequencies) as illustrated in FIG. 6.

FIG. 6 illustrates an example antenna structure 600 according to embodiments of the present disclosure. An embodiment of the antenna structure 600 shown in FIG. 6 is for illustration only.

In this case, one CSI-RS port is mapped onto a large number of antenna elements which can be controlled by a bank of analog phase shifters 601. One CSI-RS port can then correspond to one sub-array which produces a narrow analog beam through analog beamforming 605. This analog beam can be configured to sweep across a wider range of angles 620 by varying the phase shifter bank across symbols or subframes. The number of sub-arrays (equal to the number of RF chains) is the same as the number of CSI-RS ports N_{CSI-PORT}. A digital beamforming unit 610 performs a linear combination across N_{CSI-PORT} analog beams to further increase precoding gain. While analog beams are wideband (hence not frequency-selective), digital precoding can be varied across frequency sub-bands or resource blocks. Receiver operation can be conceived analogously.

Since the aforementioned system utilizes multiple analog beams for transmission and reception (wherein one or a small number of analog beams are selected out of a large number, for instance, after a training duration—to be performed from time to time), the term “multi-beam operation” is used to refer to the overall system aspect. This includes, for the purpose of illustration, indicating the assigned DL or UL TX beam (also termed “beam indication”), measuring at least one reference signal for calculating and performing beam reporting (also termed “beam measurement” and “beam reporting,” respectively), and receiving a DL or UL transmission via a selection of a corresponding RX beam.

The aforementioned system is also applicable to higher frequency bands such as >52.6 GHz. In this case, the system can employ only analog beams. Due to the O2 absorption loss around 60 GHz frequency (˜10 dB additional loss @100 m distance), larger number of and sharper analog beams (hence larger number of radiators in the array) may be needed to compensate for the additional path loss.

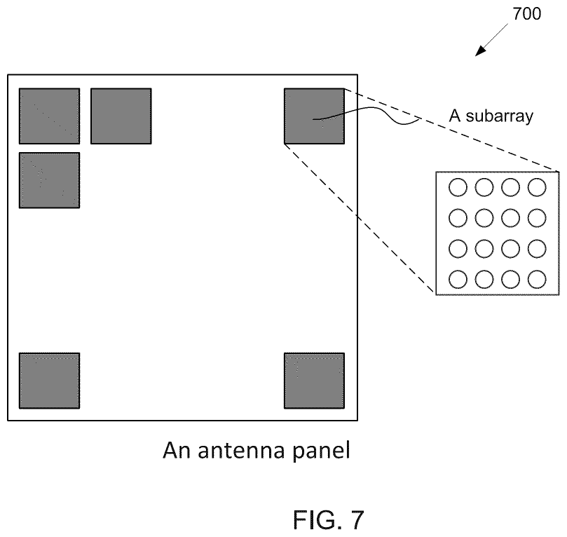

FIG. 7 illustrates an example of an antenna panel comprising NT antenna elements 700 according to embodiments of the present disclosure. An embodiment of the antenna panel comprising NT antenna elements 700 shown in FIG. 7 is for illustration only.

FIG. 7 describes an antenna panel comprising N_{T} antenna elements, which are partitioned into subarrays of equal number of elements, say N_{A} antenna elements. The total number of subarrays is denoted as N_{D}, and N_{D}=N_{T}/N_{A}.

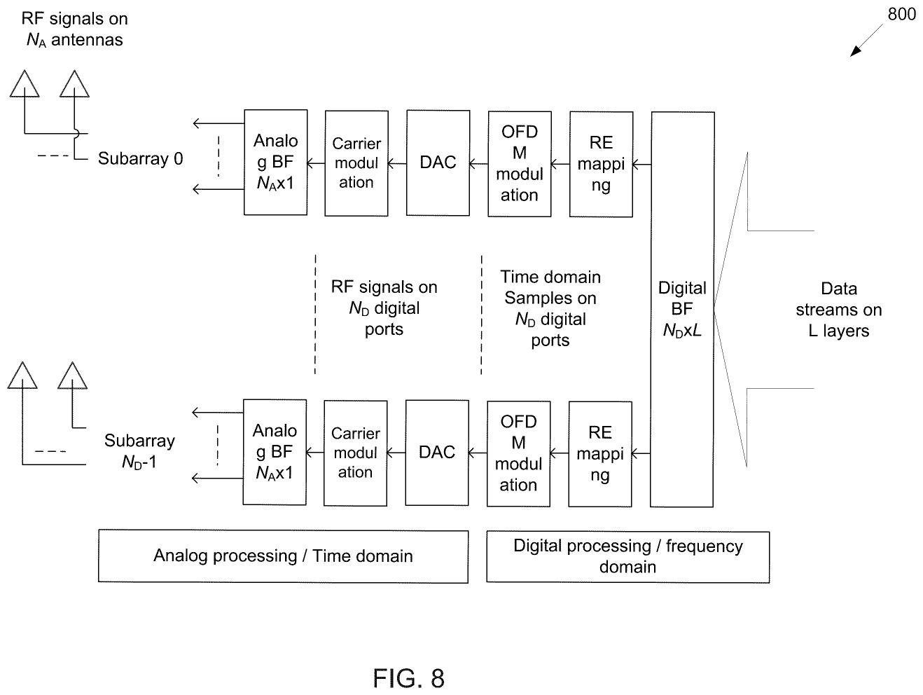

FIG. 8 illustrates an example of RF frontend and baseband implementation for a base station 800 according to embodiments of the present disclosure. An embodiment of the RF frontend and baseband implementation for a base station 800 shown in FIG. 8 is for illustration only.

FIG. 8 shows a RF frontend and baseband implementation for a base station equipped with the antenna panel in FIG. 7. This RF frontend is one possible implementation of hybrid analog-digital beamforming. The N_{T} RF signals to be emitted from the antenna panel is constructed according to FIG. 8.

Starting from the right, L data streams, or L sequences of modulation symbols are provided to digital beamformer (BF), which may convert L streams to N_{D} data streams, with multiplying a digital precoder pₖ^{D}, whose dimension is N_{D}×L, on the resource elements comprising PRB bundle k, wherein k=0, . . . , N_{PRB-bundles}−1, and N_{PRB-bundles} is the total number of PRB bundles that the data stream is mapped to.

The modulation symbols on each of N_{D} data streams are then mapped to resource elements, go through OFDM modulation, and are finally converted to time domain samples. These time domain samples are converted to analog, go through carrier modulation, and an analog signal is obtained for each of these N_{D} paths.

Then, the analog signal goes through analog BF block, where an analog precoder p_{d}^{A} of size N_{A}×1 is applied for path d, where d=0, . . . , N_{D}−1. Applying analog BFs for the signals on all the N_{D} paths, the RF signals on N_{T}=N_{A}×N_{D} antenna elements are constructed.

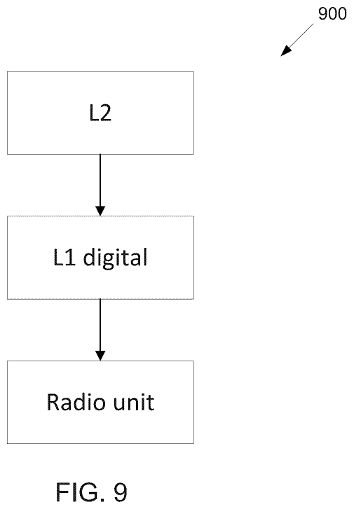

FIG. 9 illustrates an example of chain of signal processing modules 900 according to embodiments of the present disclosure. An embodiment of the chain of signal processing modules 900 shown in FIG. 9 is for illustration only.

FIG. 9 illustrates a chain of signal processing modules in a wireless transmission/reception system. L2 (layer 2) takes care of scheduling and L1 digital (layer) configurations. L1 digital module generates frequency or time domain signals according to the configurations received from L2, and passes the time or frequency domain signals to a radio unit (RU). RU then converts the digital signal to analog signal, and modulate the signal to RF frequency, performs analog beamforming (if configured), and transmits the signals over the air via antennas.

With eXtreme MIMO (X-MIMO) that may be deployed in upper mid band (7 to 24 GHz carriers), channel spectral efficiency is expected to increase by multiple times, with allowing for extremely large number of antennas, e.g., 2048, and large number of digital chains, e.g., 256. With X-MIMO, 64 layer MU-MIMO and 16 layer SU-MIMO are feasible by exploiting these many antennas and channel degrees of freedom. However, with having so many antennas to process, multiple challenges arise.

First, the complexity to construct 256×64 MU-MIMO channel matrices is expected to be at least 64× higher than 64×16 counterparts. Hence, if a BS had 20 DSP cores to deal with 64×16, 1280 DSP cores are needed for 256×64 based on straightforward extension of the 64×16 computational algorithms. Hence, multiple techniques are required to reduce the precoder complexity in a reasonable level.

Second, the channel state information (CSI) on individual digital ports is likely to be obtained with lower SINR than C-band (3.5 GHz) counterparts. This is because the pathloss is about 6-17 dB higher at 7-24 GHz of the upper middle band, and the beamforming techniques that were used for data channels for CSI acquisition may not be straightforwardly used.

The baseband processing unit of the BS needs per-user CSI for single-user and multi-user MIMO beamforming and scheduling. Here, the CSI for user i includes at least a channel vector hᵢ comprising N_{T} entries for each resource element. The length-N_{T} channel vector hᵢ can be represented by two components, a digital channel vector hᵢ^{D}=[h_{i,1}^{D}, h_{i,2}^{D}, . . . , h_{i,N}_{_{D}}^{D}] of length N_{D} and a set of N_{D} channel vectors hᵢ^{A}(d) on the subarrays of length N_{A}, d=1, . . . , N_{D}, according to the following:

$${h}_{i} = [ \begin{matrix}\begin{matrix}\begin{matrix}{h}_{i , 1}^{D} {h}_{i}^{A} ( 1 ) \\ {h}_{i , 2}^{D} {h}_{i}^{A} ( 2 )\end{matrix} \\ ⋮\end{matrix} \\ {h}_{i , {N}_{D}}^{D} {h}_{i}^{A} ( {N}_{D} )\end{matrix} ] .$$

In this general formulation where subarrays have different analog beams, the DU needs to estimate N_{T}=N_{D}·N_{A} entries, which can be as large as 2048 or even more, which requires large SRS resource overhead and computational complexity.

Therefore, low-complexity high-precision channel vector/matrix estimation for an antenna panel with extremely large number of antennas, is critical for realizing extreme MIMO performance gain.

The present disclosure provides for a base station that employs per-subarray hybrid analog-digital beamforming architecture to estimate channel state information using sounding reference signals.

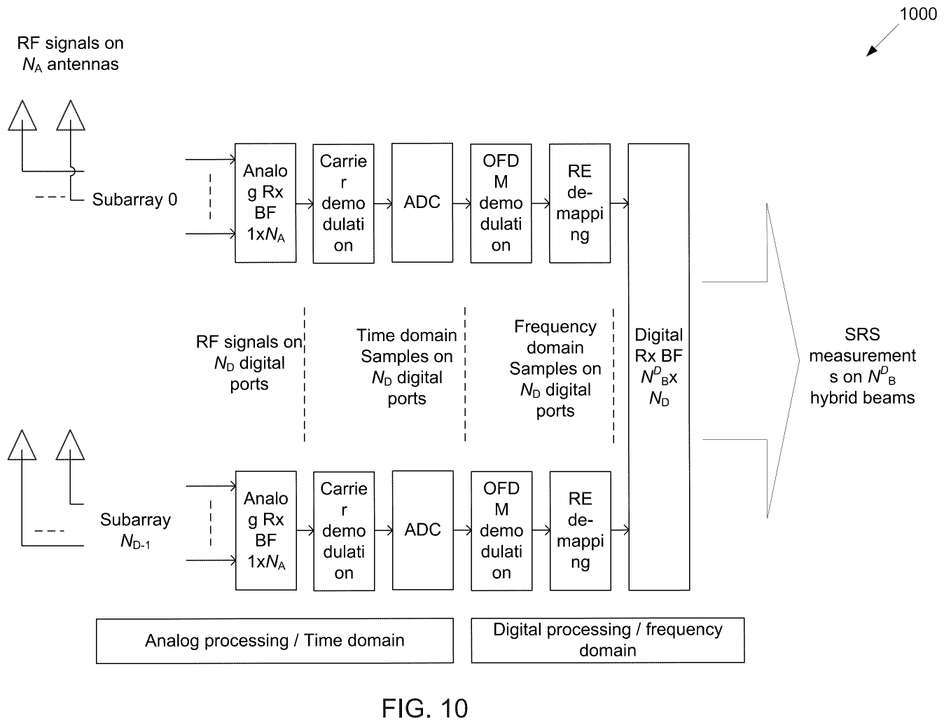

FIG. 10 illustrates an example of SRS reception and processing 1000 according to embodiments of the present disclosure. An embodiment of the SRS reception and processing 1000 shown in FIG. 10 is for illustration only.

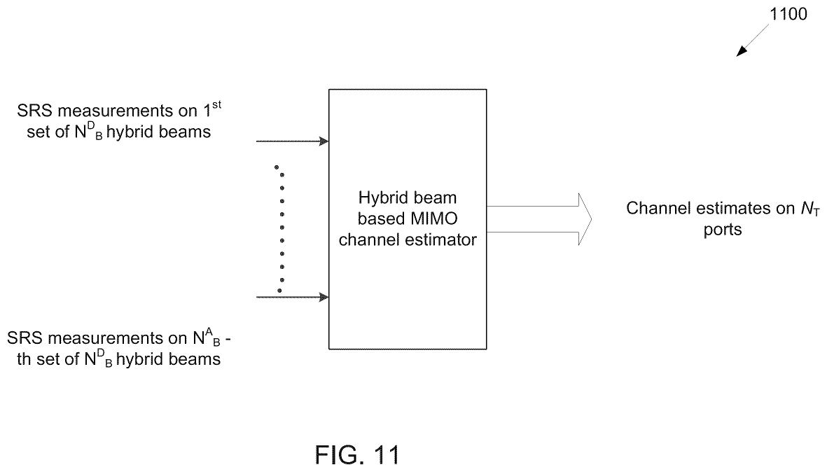

FIG. 11 illustrates an example of MIMO channel estimation 1100 according to embodiments of the present disclosure. An embodiment of the MIMO channel estimation 1100 shown in FIG. 11 is for illustration only.

FIG. 9 describes MIMO channel estimation method using SRS measurement inputs measured on a number of hybrid beams according to some embodiments of the present disclosure.

In FIG. 10, starting from the left, BS antennas receive RF signals on N_{A} antennas on each subarray during a time duration, e.g., an OFDM symbol duration or a time slot duration.

On each subarray, an analog receiver BF (Rx BF) is applied across those RF signals received on those elements comprising the subarray. Analog beamforming weights (BFWs) on these N_{D} subarrays are configured by the BS for the time duration. The analog Rx BF block combines the N_{A} signals received on each subarray into one RF signal.

Each RF signal goes through the rest of the processing chains up to OFDM demodulation, resulting in a digital Rx signal stream in the frequency domain. Then, for each configured SRS resource, the Rx stream goes through RE demapping, so that a resource specific SRS measurement stream can be obtained for each digital port. This way, for each SRS resource, N_{D} SRS measurement streams on N_{D} digital ports (i.e., one SRS measurement stream per digital port) are obtained.

These SRS resources are allocated to UE. BS configures a UE with one or more SRS resources, wherein each SRS resource is used for the UE to transmit SRS on a UE antenna port on the designated set of resource elements with applying certain scrambling code, e.g., ZC sequence with applying a specific cyclic shift configured by the BS.

Then these N_{D} Rx SRS measurement streams on N_{D} ports go through digital Rx BF (or combiner) block, resulting in Nil SRS measurement streams, wherein N_{B}^{D}<=N_{D}.

This process is repeated in N_{B}^{A} number of time durations with applying different analog beams in different time durations, which results in B SRS measurement streams, wherein B=N_{B}^{D}·N_{B}^{A}, which may be input to the channel synthesizer described in FIG. 11.

In the context of hybrid analog digital beamforming, the positive integer N_{B}^{D} is also referred to as the number of digital beams, the positive integer N_{B}^{A} is also referred to as the number of analog beams, and B=N_{B}^{D}·N_{B}^{A} is referred to as number of hybrid beams.

As depicted in FIG. 11, these N_{B} SRS measurement streams are used to estimate per antenna channel estimates across N_{T}, where N_{T}=N_{D}·N_{A}, i.e., total number of antenna elements in the antenna panel.

To help reduce complexity and overhead for SRS channel estimation, a few new methods are provided on how to use these N_{B} SRS measurement streams to estimate SRS on N_{T} antennas.

In these methods, the hybrid-beam-based MIMO channel estimator in FIG. 10 effectively performs a linear combination of SRS measurements on these hybrid beams.

In some embodiments (method 1), it is provided to use the same analog Rx BF across all the subarrays in each time duration, and apply the identity digital Rx BF (i.e., the identity matrix of size N_{D}×N_{D}) to get N_{D}·B SRS measurement streams across B=N_{B}^{A} time durations. It is noted that the digital Rx BF block can be bypassed to get the same outcome as the identity matrix. In this case, the N_{T} antenna channel vector hᵢ for user i is computed from B SRS measurements across B time durations as in the following:

$${h}_{i} = {Σ}_{b = 1}^{B} [ \begin{matrix}\begin{matrix}\begin{matrix}{h}_{i , 1}^{D} ( b ) {p}^{A} ( b ) \\ {h}_{i , 2}^{D} ( b ) {p}^{A} ( b )\end{matrix} \\ ⋮\end{matrix} \\ {h}_{i , {N}_{D}}^{D} ( b ) {p}^{A} ( b )\end{matrix} ] = {Σ}_{b = 1}^{B} {h}_{i}^{D} ( b ) ⊗ {p}^{A} ( b )$$

wherein ⊗ is Kronecker product. Application of the same analog Rx beams is motivated by the fact that all the subarray's physical channel responses on subarray elements for a given UE are similar in the far field.

Based on this method, the BS estimates CSI hᵢ as in the following.

The BS applies a same analog beam, p^{A} (b), across all the N_{D} subarrays of the panel for SRS reception during a time duration b. Then, the N_{D} SRS measurements are obtained according to FIG. 8 with applying the digital precoder of the identity matrix of size N_{D}×N_{D}. In this case, N_{D} SRS measurements for analog beam b in time duration b correspond to hᵢ^{D}(b)=[h_{i,1}^{D}(b), h_{i,2}^{D}(b), . . . , h_{i,N}_{_{D}}^{D}(b)]^{T}, b=1, . . . , B. Here, h_{i,d}^{D}(b) is channel estimates for user i on digital port d, measured with analog beam b, and is obtained from x_{d}^{D}(b)x_{d}^{D}(b) is the combined signal on digital port d on user i. x_{d}^{D}(b) is obtained with applying an analog beam p^{A}(b) on length N_{A} analog signal vector x_{d}^{A}(b) received on d-th subarray, i.e., x_{d}^{D}(b)=x_{d}^{A}(b)·p^{A}(b).

Executing these steps B times, the BS obtains B sets of SRS measurement streams, wherein each set comprises N_{D} port SRS measurement streams. Having acquired these N_{D}·B SRS measurement steams, i.e., {hᵢ^{D}(b)}_{b=1}^{B} on these analog beams {p^{A}(b)}_{b=1}^{B} applied on B time durations, the BS estimates the CSI of user i, according to the equation of method 1.

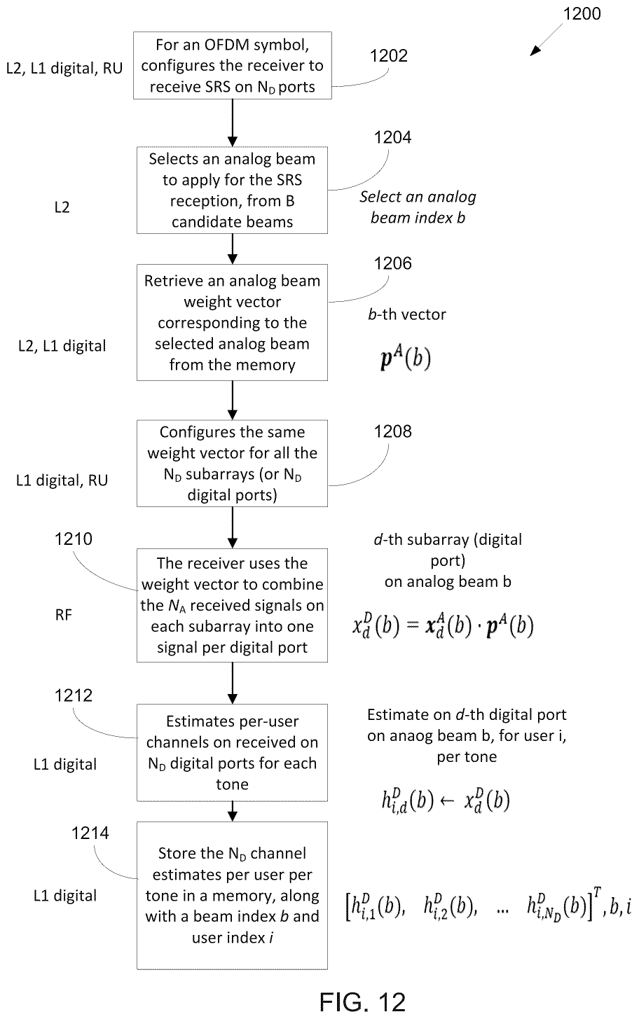

FIG. 12 illustrates a flowchart of BS method 1200 for obtaining N_{D} SRS channel measurements per subcarrier according to embodiments of the present disclosure. The BS method 1200 as may be performed by a BS (e.g., 101-103 as illustrated in FIG. 1). An embodiment of the BS method 1200 shown in FIG. 12 is for illustration only. One or more of the components illustrated in FIG. 12 can be implemented in specialized circuitry configured to perform the noted functions or one or more of the components can be implemented by one or more processors executing instructions to perform the noted functions.

FIG. 12 illustrates a method according to some embodiments of the present disclosure, to obtain a set of N_{D} SRS channel measurements per subcarrier (or per tone). For an OFDM symbol configured for SRS, the BS configures a same analog beam for all the N_{D} subarrays selected from B candidate beams. The base station may select analog beams sequentially across different SRS reception opportunities (i.e., OFDM symbols configured for SRS reception). For example, if there are N_{A}=4 analog beams to apply for SRS reception, say, beam 1, beam 2, beam 3 and beam 4, then these beams are sequentially applied across four different SRS reception opportunities. Subsequently, hᵢ^{D}(b)=[h_{i,1}^{D}(b), h_{i,2}^{D}(b), . . . , h_{i,N}_{_{D}}^{D}(b)]^{T}, b=1, . . . , B for each i and b are obtained according to some embodiments of the present disclosure.

As illustrated in FIG. 12, in step 1202, the BS configure the receiver to receive SRS. In step 1204, the BS selects an analog beam to apply for the SRS reception. In step 1206, the BS retrieves an analog beam weight vector. In step 1208, the BS configures the same weight vector. In step 1210, the BS uses the weight vector to combine the N_{A} received signals. In step 1212, the BS estimates per user channels. In step 1214, the BS stores the N_{D} channel estimates per user per tone in a memory.

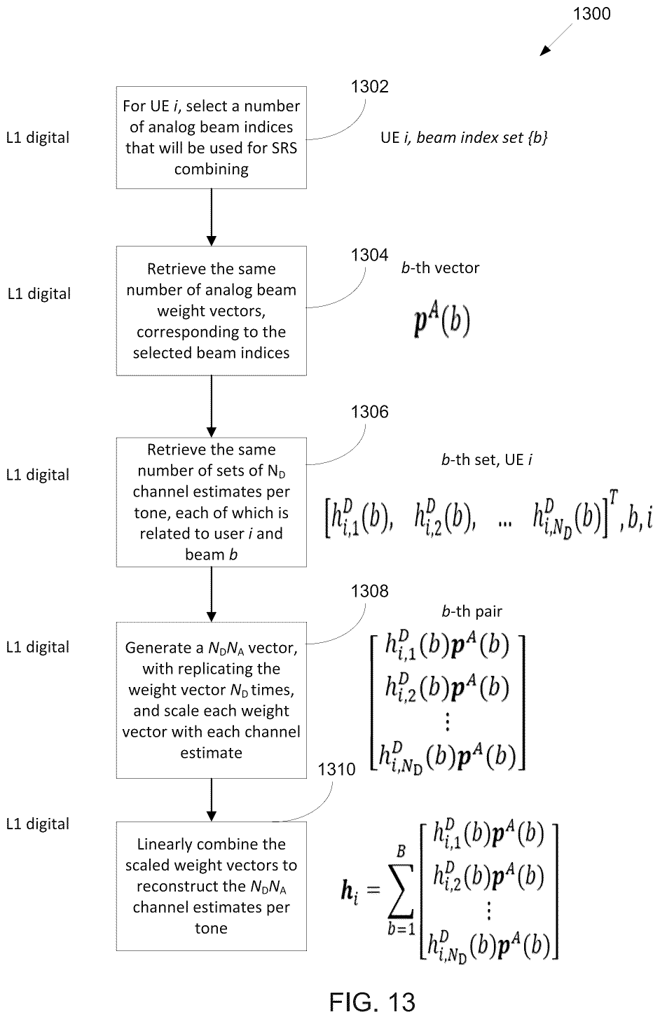

FIG. 13 illustrates a flowchart of BS method 1300 to reconstruct a channel matrix according to embodiments of the present disclosure. The BS method 1300 as may be performed by a BS (e.g., 101-103 as illustrated in FIG. 1). An embodiment of the BS method 1300 shown in FIG. 13 is for illustration only. One or more of the components illustrated in FIG. 13 can be implemented in specialized circuitry configured to perform the noted functions or one or more of the components can be implemented by one or more processors executing instructions to perform the noted functions.

FIG. 13 illustrates a method according to some embodiments of the present disclosure, to reconstruct a channel matrix for a number of antenna ports comprising analog ports in addition to digital ports. The BS combines a set of channel estimates collected across multiple time durations to reconstruct a full channel matrix, comprising dimensions associated with analog ports as well as digital ports. For each UE, the BS selects a number of analog beam indices that may be used for the combining, after collecting B sets of ND SRS channel measurements per subcarrier according to some embodiments of the present disclosure.

The BS combines these sets of channel estimates, and reconstruct the N_{A}N_{D} channel estimates per subcarrier. After combining, the analog-port channel estimates are also available in addition to the digital-port channel estimates.

As illustrated in FIG. 13, in step 1302, the BS selects a number of analog beam indices. In step 1304, the BS retrieves the same number of analog beam weight vectors. In step 1306, the BS retrieves the same number of sets of N_{D} channel estimates per tone. In step 1308, the BS generates a N_{D}N_{A} vector. In step 1310, the BS linearly combine the scaled weight vectors to reconstruct the N_{D}N_{A} channel estimates per tone.

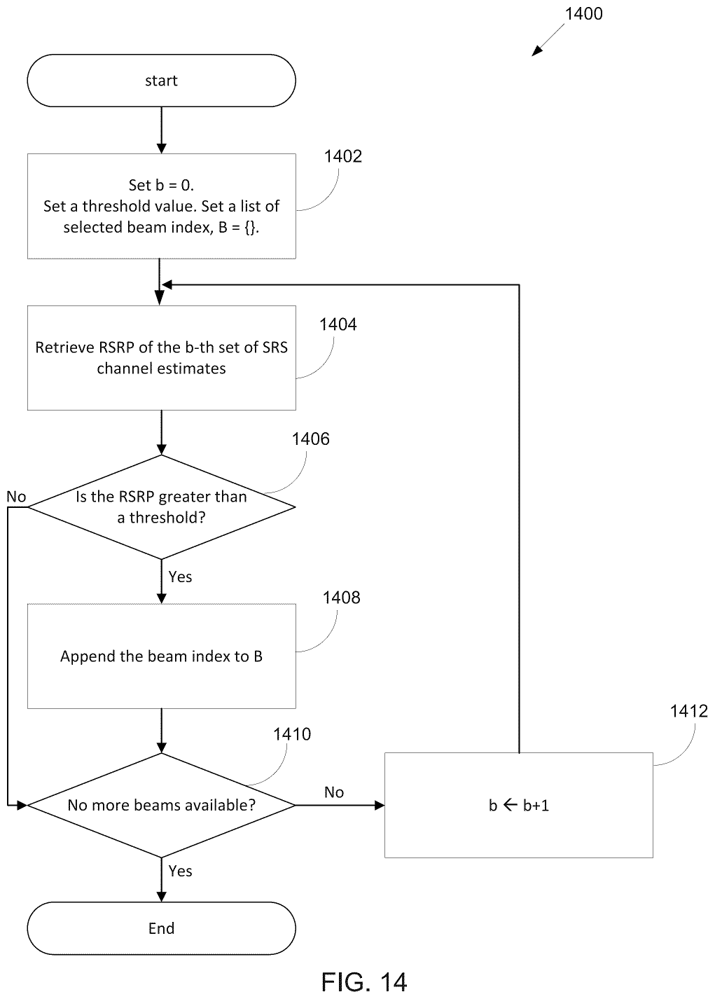

FIG. 14 illustrates a flowchart of BS method 1400 for a subset of SRS analog beams according to embodiments of the present disclosure. The BS method 1400 as may be performed by a BS (e.g., 101-103 as illustrated in FIG. 1). An embodiment of the BS method 1400 shown in FIG. 14 is for illustration only. One or more of the components illustrated in FIG. 14 can be implemented in specialized circuitry configured to perform the noted functions or one or more of the components can be implemented by one or more processors executing instructions to perform the noted functions.

FIG. 14 illustrates a method to UE-specifically select a subset of SRS analog beams for the combining, according to some embodiments of the present disclosure. The flow chart is executed per user. For the down-selection of the SRS beams that may be used for the combining, BS considers the SRS channel strengths received on these different analog beams. In one example, the BS down-selects a subset of beams that achieves SRS RSRP (or alternatively SINR or RSSI) greater than a threshold. These down-selected beams are used for the combining instead of the full B sets, to reconstruct analog port channel estimates.

As illustrated in FIG. 14, in step 1402, the BS sets b and a threshold value. In step 1404, the BS retrieves RSRP of the b-th set of SRS channel estimates. In step 1406, the BS determine whether the RSRP is greater than a threshold. In step 1408, the BS append the beam index to B. In step 1410, the BS determine whether more beams are available. In step 1412, the BS set B.

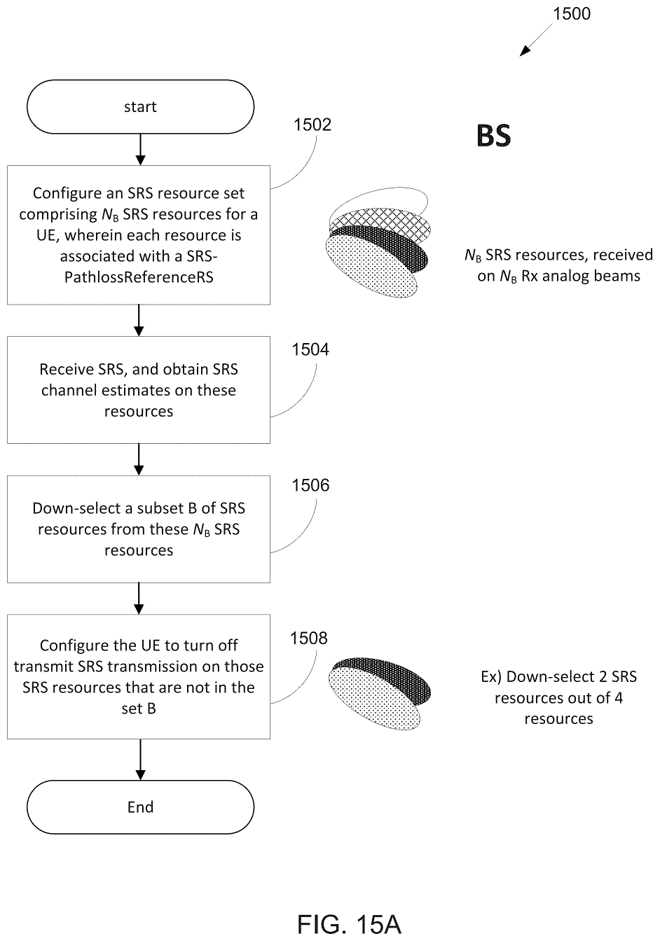

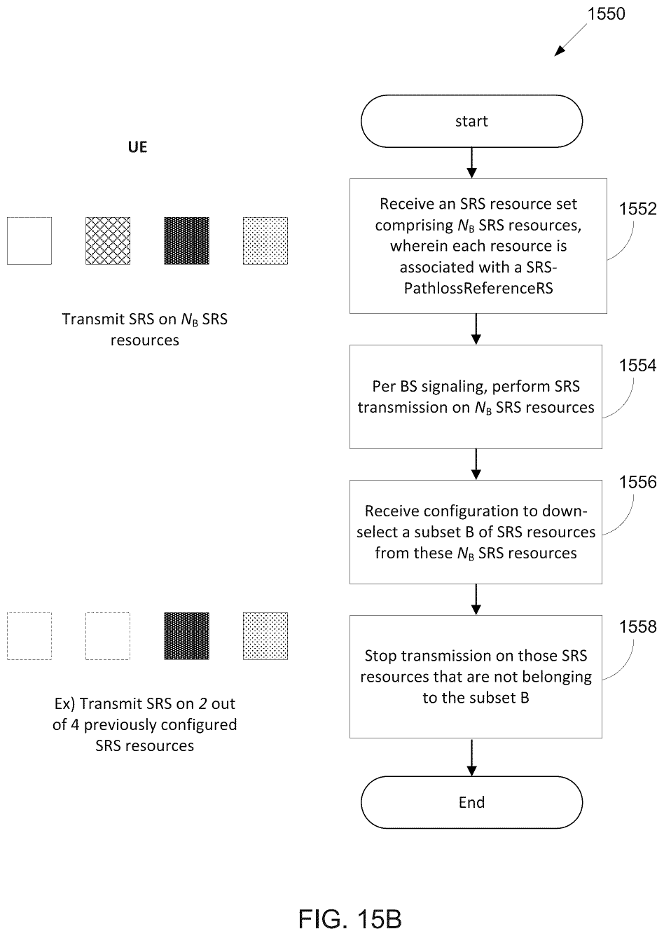

FIG. 15A illustrates a flowchart of BS method 1500 to configure multiple SRS resources according to embodiments of the present disclosure. The BS method 1500 as may be performed by a BS (e.g., 101-103 as illustrated in FIG. 1). An embodiment of the BS method 1500 shown in FIG. 15A is for illustration only. One or more of the components illustrated in FIG. 15A can be implemented in specialized circuitry configured to perform the noted functions or one or more of the components can be implemented by one or more processors executing instructions to perform the noted functions.

FIG. 15A illustrates a method to configure multiple SRS resources to a UE, and later selectively turns off the SRS transmission of the UE, according to some embodiments of the present disclosure. After generating SRS channel estimates from all the configured SRS resources, the BS runs through the SRS beam subset selection procedure according to some embodiments. Then, the BS sends the information of the selected subset to the UE, with which the UE may continue the SRS transmission only on the selected subset of SRS resources. Alternatively, the BS transmits an information of a subset of SRS resources for which the UE needs to turn off the SRS transmissions. BS transmits the information via a RRC, a MAC CE, or a DCI signaling.

As illustrated in FIG. 15A, in step 1502, the BS configures an SRS resource set. In step 1504, the BS receives SRS and obtain SRS channel estimates on the resources. In step 1506, the BS down-selects a subset B of SRS resources. In step 1508, the BS configures the UE to turn off transmits SRS transmission.

FIG. 15B illustrates a flowchart of UE method 1550 to configure multiple SRS resources according to embodiments of the present disclosure. The UE method 1550 as may be performed by a UE (e.g., 111-116 as illustrated in FIG. 1). An embodiment of the UE method 15500 shown in FIG. 15B is for illustration only. One or more of the components illustrated in FIG. 15B can be implemented in specialized circuitry configured to perform the noted functions or one or more of the components can be implemented by one or more processors executing instructions to perform the noted functions.

As illustrated in FIG. 15B, in step 1552, the UE receives an SRS resource set comprising N_{B} SRS resources, wherein each resource is associated with a SRS-PathlossReferenceRS. In step 1554, the UE. per BS signaling, performs SRS transmission on N_{B} SRS resources. In step 1556, the UE receives configuration to down-select a subset B of SRS resources from these NB SRS resources. In step 1558, the UE stops transmission on those SRS resources that are not belonging to the subset B.

These embodiments in FIG. 14 and FIGS. 15A and 15B are useful to save UE's battery consumption, by allowing the UE not to transmit SRS on those resources for which the quality of the SRS channel estimates is limited because the SRS Rx beam direction is not aligned with the UE's channel direction.

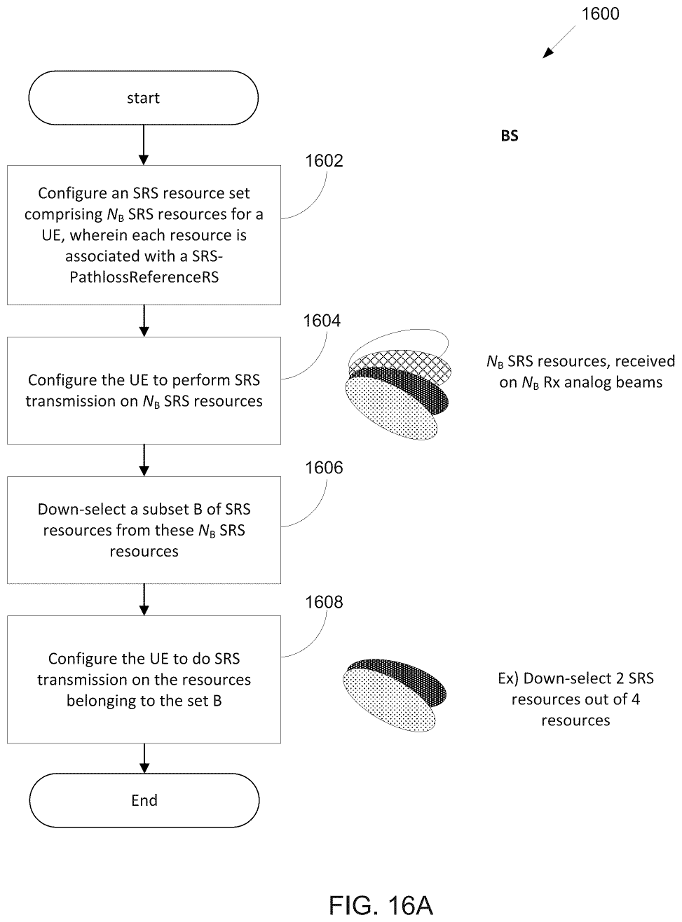

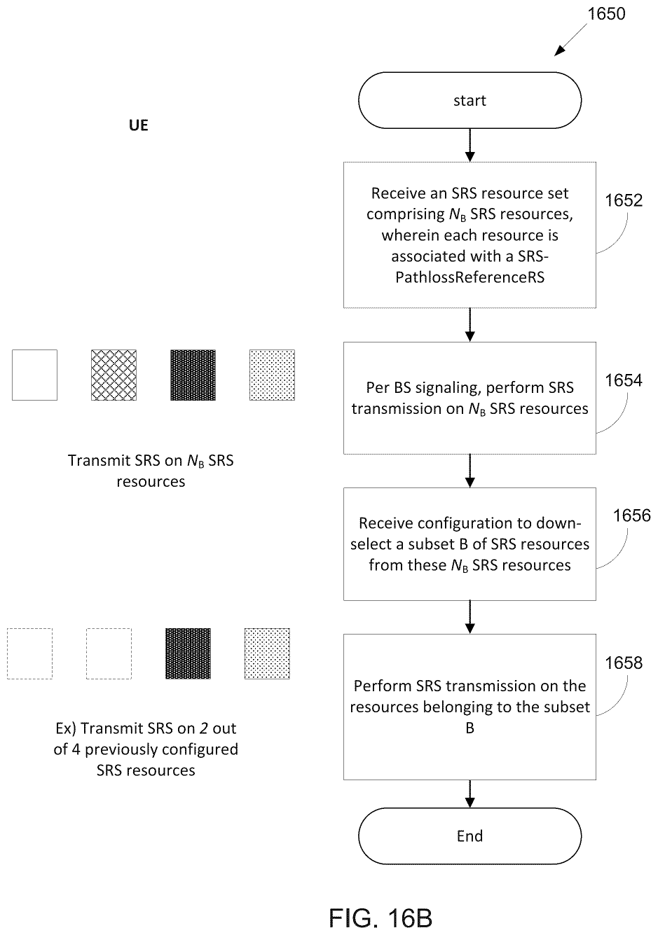

FIG. 16A illustrates a flowchart of BS method 1600 to inform the down-selection of SRS resources according to embodiments of the present disclosure. The BS method 1600 as may be performed by a BS (e.g., 101-103 as illustrated in FIG. 1). An embodiment of the BS method 1600 shown in FIG. 16A is for illustration only. One or more of the components illustrated in FIG. 16A can be implemented in specialized circuitry configured to perform the noted functions or one or more of the components can be implemented by one or more processors executing instructions to perform the noted functions.

FIG. 16A illustrates a method for BS to inform the down-selection of SRS resources for a UE, according to some embodiments of the present disclosure. The BS configures multiple SRS resources to a UE, and configure a first SRS and a second transmissions for the multiple SRS resources. The BS configures the UE to perform the first SRS transmission on the full set of SRS resources as configured in the SRS resource set. The BS measures the signal quality of these SRS resources, and down-select a subset B′ of SRS resources. Then, the BS configures the UE to do the second SRS transmission on the subset B′ of SRS resources.

As illustrated in FIG. 16A, in step 1602, the BS configures an SRS resource set. In step 1604, the BS configures the UE to perform STS transmission on the resources. In step 1606, the BS down-selects a subset B of SRS resources. In step 1608, the BS configures the UE to perform the SRS transmission.

FIG. 16B illustrates a flowchart of UE method 1650 to inform the down-selection of SRS resources according to embodiments of the present disclosure. The UE method 1650 as may be performed by a BS (e.g., 101-103 as illustrated in FIG. 1). An embodiment of the UE method 1650 shown in FIG. 16B is for illustration only. One or more of the components illustrated in FIG. 16B can be implemented in specialized circuitry configured to perform the noted functions or one or more of the components can be implemented by one or more processors executing instructions to perform the noted functions.

As illustrated in FIG. 16B, the UE, in step 1652, receives an SRS resource set comprising N_{B} SRS resources, wherein each resource is associated with a SRS-PathlossReferenceRS. In step 1654, the UE, per BS signaling, performs SRS transmission on N_{B} SRS resources. In step 1656, the UE receives configuration to down-select a subset B of SRS resources from these N_{B} SRS resources. In step 1658, the UE performs SRS transmission on the resources belonging to the subset B.

In some embodiments, DCI signaling is used for the SRS transmission triggering related to FIGS. 15A and 15B. The DCI field used for the SRS triggering is a bitmap signaling, wherein each bit indicates whether a certain SRS resource needs to be turned on (i.e., for the UE to transmit) or off (i.e., for the UE to skip the transmission).

In some embodiments, a MAC CE signaling is used for configuring turning on/off these configured SRS resources in the SRS resource set.

As such, the UE receives an SRS resource set configuration, and transmits SRS across all the resources in the set. After a while, the UE receives another indication via DCI or MAC CE to selectively turn off (or alternatively to selectively turn on) certain SRS resources among those resources in the configured SRS resource set. Accordingly, the UE stops transmitting SRS on those indicated “off” resources; and the UE continue transmitting SRS only on those indicated “on” resources.

In FIGS. 15A and 15B and FIGS. 16A and 16B, the UE is originally configured with an SRS resource set comprising N_{B}=4 SRS resources. UE is then configured to transmit SRS on those four SRS resources. After a while, the BS decides to turn off 2 out of 4 four SRS resources, and transmits such a DCI or MAC CE signaling. Upon receiving the signaling, the UE stops transmitting the SRS on those “turned off” (or “disabled”) SRS resources, while the UE continues transmitting the SRS on those resources that are not turned off (or “not disabled” or “turned on”).

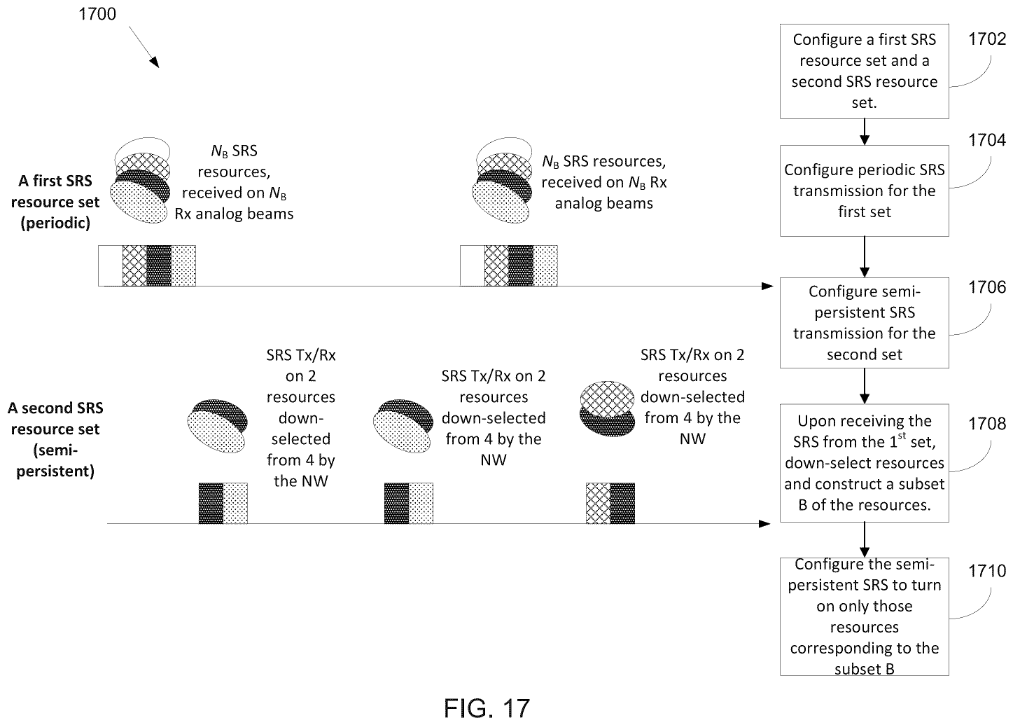

FIG. 17 illustrates a flowchart of BS method 1700 for two SRS resource set configuration and management according to embodiments of the present disclosure. The BS method 1700 as may be performed by a BS (e.g., 101-103 as illustrated in FIG. 1). An embodiment of the BS method 1700 shown in FIG. 17 is for illustration only. One or more of the components illustrated in FIG. 17 can be implemented in specialized circuitry configured to perform the noted functions or one or more of the components can be implemented by one or more processors executing instructions to perform the noted functions.

FIG. 17 illustrates two SRS resource set configuration and management according to some embodiments of the present disclosure. The BS configures a first SRS resource set and a second SRS resource set for a UE. The BS configures periodic SRS transmission for the first SRS resource set, and semi-persistent SRS transmission for the second SRS resource set. Upon receiving the SRS from the 1^{st} set, the BS down-selects the SRS resources corresponding to a set B′ of SRS Rx beams that gives relatively stronger Rx signal quality, according to some embodiments of the present disclosure. The BS updates the semi-persistent SRS transmission configuration to turn on only those resources corresponding to these down selected SRS Rx beams. When the BS receives another SRS transmission on the first resource set, the BS re-assess the Rx signal quality on the Rx beams, and updates the beam down selection set B′. If the BS selects a new subset, then the BS subsequently updates the semi-persistent SRS configuration to turn on only those SRS resources corresponding to the newly selected SRS beams.

As illustrated in FIG. 17, in step 1702, the BS configures a first SRS resource set and a second SRS resource set. In step 1704, the BS configures periodic SRS transmission for the first set. In step 1706, the BS configures semi-persistent SRS transmission for the second set. In step 1708, the BS, upon receiving the SRS from the first set, down-selects resources and construct a subset B of the resources. In step 1710, the BS configures the semi-persistent SRS to turn on only those resources corresponding to the subset B.

While method 1 simplifies channel estimation with making all the analog beams across all the subarrays at each time instance the same, individual channel estimates, i.e., entries of hᵢ^{D}(b) may suffer from large estimation errors especially when SRS SINR is low, which result in poor hᵢ estimates, low-quality MU-MIMO precoders, and low MU-MIMO throughput.

To improve accuracy of SRS channel estimation even under low SRS SINR condition and/or reduce complexity of the SRS channel estimation, another method (method 2) is provided. With the new method, the channel vector for user i is constructed as in the following:

$${h}_{i} = {Σ}_{{b}_{2} = 1}^{{N}_{B}^{D}} {Σ}_{{b}_{1} = 1}^{{N}_{B}^{A}} {h}_{{b}_{1} , {b}_{2}} {p}^{D} ( {b}_{1} , {b}_{2} ) ⊗ {p}^{A} ( {b}_{1} ) .$$

Based on this method, the BS estimates CSI hᵢ as in the following. The BS applies the same analog Rx BF across all the subarrays in each time duration, and a digital Rx BF using a N_{B}^{D}×N_{D} matrix to get N_{B}^{A}·N_{B}^{D} SRS measurement streams across N_{B}^{A} time durations.

The BS applies a same analog beam, p^{A}(b₁), across all the N_{D} subarrays of the panel for SRS reception during a time duration b₁. Then, the N_{D} SRS measurements are obtained according to FIG. 7 with applying a digital Rx combiner matrix, P^{D}, of size N_{B}^{D}×N_{D}. Upon applying the digital Rx combiner P^{D}(b₁) of size N_{B}^{D}×N_{D} on N_{D} SRS measurement streams for time duration b₁, the BS obtains:

$${h}_{i}^{D B} ( {b}_{1} ) = {P}^{D} ( {b}_{1} ) {h}_{i}^{D} ( {b}_{1} ) = {[ \begin{matrix}\begin{matrix}\begin{matrix}{p}^{D} ( {b}_{1} , 1 ) , & {p}^{D} ( {b}_{1} , 2 ) ,\end{matrix} & …\end{matrix} & {p}^{D} ( {b}_{1} , {N}_{B}^{D} )\end{matrix} ]}^{T} [ \begin{matrix}\begin{matrix}\begin{matrix}{h}_{i , 1}^{D} ( {b}_{1} ) \\ {h}_{i , 2}^{D} ( {b}_{1} )\end{matrix} \\ ⋮\end{matrix} \\ {h}_{i , {N}_{D}}^{D} ( {b}_{1} )\end{matrix} ] = [ \begin{matrix}\begin{matrix}\begin{matrix}{h}_{{b}_{1} , 1} \\ {h}_{{b}_{1} , 2}\end{matrix} \\ ⋮\end{matrix} \\ {h}_{{b}_{1} , {N}_{B}^{D}}\end{matrix} ] .$$

This way, for each hybrid analog & digital beam p^{D}(b₁, b₂)⊗p^{A}(b₁), one SRS Rx measurement stream, h_{b}_{₁}_{,b}_{₂}, is obtained, resulting in hᵢ^{DB}(b₁). This hᵢ^{DB}(b₁) is used for reconstructing hᵢ based on the reconstruction equation of method 2, along with the network configured analog and digital beams of

$${\{ {P}^{D} ( {b}_{1} ) \}}_{{b}_{1} = 1}^{{N}_{{B}_{1}}} and {\{ {p}^{D} ( {b}_{1} ) \}}_{{b}_{1} = 1}^{{N}_{{B}_{1}}} ,$$

respectively.

In some embodiments, the vector sets {p^{A}(b)}_{b=1}^{N}^{_{B}}^{^{A}} and

$${\{ {p}^{D} ( {b}_{1} , {b}_{2} ) ⊗ {p}^{A} ( {b}_{1} ) \}}_{{b}_{1} ∈ \{ 1 , … , {N}_{B}^{A} \} , {b}_{2} ∈ \{ 1 , … , {N}_{B}^{D} \}}$$

is chosen such that all the vectors in the set are orthogonal to each other and these vectors are of a unit norm, i.e., the sum of magnitude square of the entries add up to one.

In one example, vectors for these vector set are those column vectors from a DFT matrix.

In one example, vectors for these vector set are those column vectors from a matrix constructed with taking Kronecker product of columns of two DFT matrices.

For extreme MIMO base stations where number of antenna elements is in the order of 1000s, and these antennas are partitioned into subarrays of in the order of 100s, wherein analog beamforming is configured to be tunable per subarray at each time duration. The present disclosure helps the BS to estimate the CSI reliably with low computational complexity.

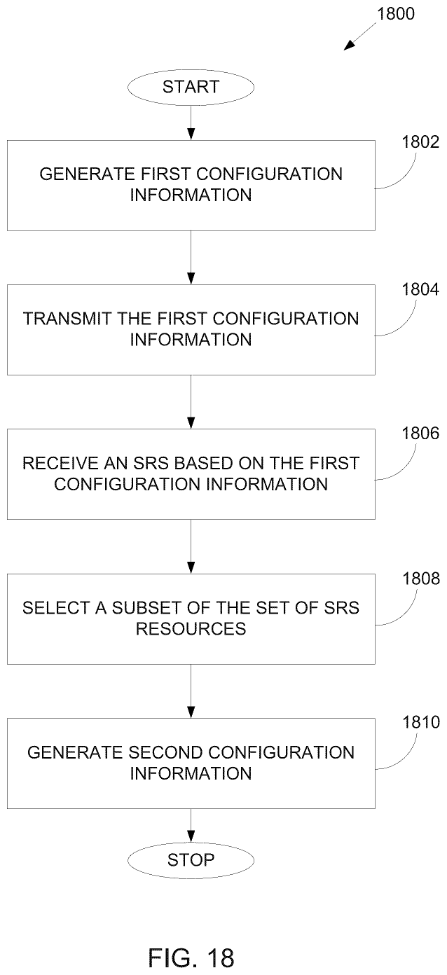

FIG. 18 illustrates a flowchart of BS method 1800 for estimating channel state information according to embodiments of the present disclosure. The BS method 1800 as may be performed by a BS (e.g., 101-103 as illustrated in FIG. 1). An embodiment of the BS method 1800 shown in FIG. 18 is for illustration only. One or more of the components illustrated in FIG. 19 can be implemented in specialized circuitry configured to perform the noted functions or one or more of the components can be implemented by one or more processors executing instructions to perform the noted functions.

As illustrated in FIG. 18, the method 1800 begins at step 1802. In step 1802, a BS generates first configuration information including a set of SRS resources each of which is associated with an SRS-path loss reference signal.

In step 1804, the BS transmits, to a UE, the first configuration information.

In step 1806, the BS receives an SRS based on the first configuration information.

In step 1808, the BS selects, based on the SRS and the first configuration information, a subset of the set of SRS resources. In one embodiment, the set of SRS resources comprises a first set of resources and a second set of resources, the first set of resources is configured for the SRS in a periodic reception, and the second set of resources is configured for the SRS in a semi-persistent reception.

In one embodiment, the first set of resources is configured for an entirety of analog beams and a down selection measurement operation to obtain the subset of the set of SRS resources and the second set of resources is configured for at least one analog beam that is down-selected from the entirety of analog beams on the subset of the set of SRS resources.

In step 1810, the BS generates second configuration information including the subset of the set of SRS resources.

In one embodiment, the BS transmits, to the UE, the second configuration information; and receives, from the UE, the SRS based on the subset of the set of SRS resources.

In one embodiment, the BS collects SRS channel estimates measured on an analog beam via a multiple SRS measurement operation.

In one embodiment, the BS constructs a channel matrix based on results of the multiple SRS measurement operation collected from different analog beams.

In one embodiment, the BS identifies, based on a DFT matrix, a set of analog beams to receive the SRS and receives the SRS based on the set of analog beams.

In one embodiment, the BS identifies a channel strength of the SRS that is received via different analog beams. In such embodiment, the channel strength is identified based on a threshold and at least one of a RSRP, a RSSI, or a SINR.

In one embodiment, the BS selects analog beams based on the channel strength of the SRS and combines the selected analog beams to perform an analog port channel estimates operation.

The above flowcharts illustrate example methods that can be implemented in accordance with the principles of the present disclosure and various changes could be made to the methods illustrated in the flowcharts herein. For example, while shown as a series of steps, various steps in each figure could overlap, occur in parallel, occur in a different order, or occur multiple times. In another example, steps may be omitted or replaced by other steps.

Although the present disclosure has been described with exemplary embodiments, various changes and modifications may be suggested to one skilled in the art. It is intended that the present disclosure encompass such changes and modifications as fall within the scope of the appended claims. None of the description in this application should be read as implying that any particular element, step, or function is an essential element that must be included in the claims scope. The scope of patented subject matter is defined by the claims.

What is claimed is:

1. A base station (BS) comprising:
a processor configured to generate first configuration information including a set of sounding reference signal (SRS) resources each of which is associated with an SRS-path loss reference signal; and
a transceiver operably coupled to the processor, the transceiver configured to:
transmit, to a user equipment (UE), the first configuration information, and
receive an SRS based on the first configuration information,
wherein the processor is further configured to:
select, based on the SRS and the first configuration information, a subset of the set of SRS resources, and
generate second configuration information including the subset of the set of SRS resources.

2. The BS of claim 1, wherein the transceiver is further configured to:
transmit, to the UE, the second configuration information; and
receive, from the UE, the SRS based on the subset of the set of SRS resources.

3. The BS of claim 1, wherein the processor is further configured to collect SRS channel estimates measured on an analog beam via a multiple SRS measurement operation.

4. The BS of claim 3, wherein the processor is further configured to construct a channel matrix based on results of the multiple SRS measurement operation collected from different analog beams.

5. The BS of claim 1, wherein:
the processor is further configured to identify, based on a discrete Fourier transform (DFT) matrix, a set of analog beams to receive the SRS; and
the transceiver is further configured to receive the SRS based on the set of analog beams.

6. The BS of claim 1, wherein:
the processor is further configured to identify a channel strength of the SRS that is received via different analog beams; and
the channel strength is identified based on a threshold and at least one of a reference signal received power (RSRP), a received signal strength indicator (RSSI), or a signal to interference noise ratio (SINR).

7. The BS of claim 6, wherein the processor is further configured to:
select analog beams based on the channel strength of the SRS; and
combine the selected analog beams to perform an analog port channel estimate operation.

8. The BS of claim 1, wherein:
the set of SRS resources comprises a first set of resources and a second set of resources;
the first set of resources is configured for the SRS in a periodic reception; and
the second set of resources is configured for the SRS in a semi-persistent reception.

9. The BS of claim 8, wherein:
the first set of resources is configured for an entirety of analog beams and a down selection measurement operation to obtain the subset of the set of SRS resources; and
the second set of resources is configured for at least one analog beam that is down-selected from the entirety of analog beams on the subset of the set of SRS resources.

10. A method of a base station (BS), the method comprising:
generating first configuration information including a set of sounding reference signal (SRS) resources each of which is associated with an SRS-path loss reference signal;
transmitting, to a user equipment (UE), the first configuration information;
receiving an SRS based on the first configuration information;
selecting, based on the SRS and the first configuration information, a subset of the set of SRS resources; and
generating second configuration information including the subset of the set of SRS resources.

11. The method of claim 10, further comprising:
transmitting, to the UE, the second configuration information; and
receiving, from the UE, the SRS based on the subset of the set of SRS resources.

12. The method of claim 10, further comprising collecting SRS channel estimates measured on an analog beam via a multiple SRS measurement operation.

13. The method of claim 12, further comprising constructing a channel matrix based on results of the multiple SRS measurement operation collected from different analog beams.

14. The method of claim 10, further comprising:
identifying, based on a discrete Fourier transform (DFT) matrix, a set of analog beams to receive the SRS; and
receiving the SRS based on the set of analog beams.

15. The method of claim 10, further comprising identifying a channel strength of the SRS that is received via different analog beams,
wherein the channel strength is identified based on a threshold and at least one of a reference signal received power (RSRP), a received signal strength indicator (RSSI), or a signal to interference noise ratio (SINR).

16. The method of claim 15, further comprising:
selecting analog beams based on the channel strength of the SRS; and
combining the selected analog beams to perform an analog port channel estimates operation.

17. The method of claim 15, wherein:
the set of SRS resources comprises a first set of resources and a second set of resources;
the first set of resources is configured for the SRS in a periodic reception; and
the second set of resources is configured for the SRS in a semi-persistent reception.

18. The method of claim 17, wherein:
the first set of resources is configured for an entirety of analog beams and a down selection measurement operation to obtain the subset of the set of SRS resources; and
the second set of resources is configured for at least one analog beam that is down-selected from the entirety of analog beams on the subset of the set of SRS resources.

19. A user equipment (UE) comprising:
a transceiver configured to receive, from a base station (BS), first configuration information; and
a processor operably coupled to the transceiver, the processor configured to identify the first configuration information including a set of sounding reference signal (SRS) resources each of which is associated with an SRS -path loss reference signal for transmitting an SRS,
wherein:
the transceiver is further configured to transmit, to the BS, the SRS based on the first configuration information,
a subset of the set of SRS resources is selected based on the SRS and the first configuration information, and
second configuration information including the subset of the set of SRS resources is identified based on subset of the set of SRS resources.

20. The UE of claim 19, wherein the transceiver is further configured to:
receive, from the BS, the second configuration information; and
transmit, to the BS, the SRS based on the subset of the set of SRS resources.
